(19) United States
(12) Patent Application Publication
(10) Pub. No.: US 2015/0016340 A1
(43) Pub. Date: Jan. 15, 2015

(54) Communication System, Gateway Control Apparatus, Path Control Apparatus, Communication Method and Program

(71) Applicants: Nobuhiko Itoh, Tokyo (JP); lppei Akiyoshi, Tokyo (JP)

(72) Inventors: Nobuhiko Itoh, Tokyo (JP); lppei Akiyoshi, Tokyo (JP)

(21) Appl. No.: 14/381,509

(22) PCT Filed: Oct. 30, 2012
(86) PCT No.: PCT/JP2012/006950

§ 371 Date: Aug. 27, 2014

(30) Foreign Application Priority Data
Mar. 1, 2012 (JP) 2012-045836

(51) Int. Cl. H04W 40/20; H04W 8/10; H04W 40/02

(52) U.S. Cl. CPC H04W 40/20; H04W 40/026; H04W 8/10; H04W 88/16
USPC 370/328

(57) ABSTRACT

A communication system includes a plurality of gateway apparatuses that connect a first network and a second network; a gateway control apparatus that selects at least one of the plurality of gateway apparatuses based on information related to location in the second network of a terminal that communicates with the first network via at least one of the plurality of gateway apparatuses; and path control means for controlling the first network so that a packet(s) having the terminal as a destination passes through the selected gateway apparatus(es).

### CROSS-REFERENCE TO RELATED APPLICATIONS

The present application claims priority from Japanese Patent Application No. JP2012-045836 (filed on Mar. 1, 2012) the content of which is hereby incorporated in its entirety by reference into this specification. The present disclosure relates to a communication system, a gateway control apparatus, a path control apparatus, a communication method and a program, and in particular to a communication system, a gateway control apparatus, a path control apparatus, a communication method and a program, where a plurality of gateways are arranged between different networks.

### TECHNICAL FIELD

### Background

As protocols that support communication where sessions are not interrupted even if a mobile terminal moves when in the middle of communicating, Mobile IPv6 (MIPv6), Proxy Mobile IPv6 (PMIPv6) and the like are cited (see Non-Patent Literature 1 and Non-Patent Literature 2).

FIG. 20 shows a configuration example of a communication system using the PMIPv6 protocol. A network X5 is, for example, the Internet. A network X6 is a network that performs communication using the Proxy Mobile IPv6 protocol (Proxy Mobile IPv6 domain).

An LMA (Local Mobility Anchor) X3 manages movement of a terminal X1. That is, the LMA X3 manages which MAG (Mobile Access Gateway) X2 the terminal X1 is connected to, when the terminal 1 moves.

The LMA X3 acts as a proxy for the terminal X1 of the network X6 (PMIPv6 domain) to perform communication between a server X4 of the network X5, which is an external network, and the terminal X1. That is, the LMA X3 receives a packet having the terminal X1 as a destination, as a proxy for the terminal X1, and forwards to the terminal X1. Furthermore it receives a packet transmitted by the terminal X1, and as a proxy for the terminal X1, forwards the packet transmitted by the terminal X1 to the destination of the packet. In this way, by the LMA X3 performing communication as a proxy for the terminal X1, a communication partner of the terminal X1 present in the external network can communicate with the terminal X1 in the PMIPv6 domain, without a function for the PMIPv6 protocol being added.

A description is giving of operation of PMIPv6, using FIG. 21. FIG. 21 shows procedures after the terminal X1 is connected to the network X6 via a MAG-A X2, until handover to a MAG-B X2. When the MAG-A X2 establishes a link with the terminal X1, in order to record the location of the terminal the MAG-A X2 adds an identifier by which the terminal can be uniquely identified, and transmits a Proxy Binding Update (PBU) to the LMA X3. The identifier by which the terminal can be uniquely identified may be, for example, a Network Access Identifier (NAI), a MAC address, or the like. Location information for the terminal, for example, is an IP address of a MAG to which the terminal is connected. For example, in the case of FIG. 21 the IP address of the MAG-A2 is used as the location information of the terminal. When the LMA X3 receives the PBU, with the identifier of the terminal as a key, a Home Network Prefix (HNP) of the terminal is selected, and the HNP, which records the location information of the terminal X1, is a prefix uniquely assigned to each terminal. Then the LMA X3 generates tunnel information so as to enable a packet having the terminal X1 as a destination to be forwarded to the MAG-A X2. Thereafter, the LMA X3 notifies the MAG-A X2 of the HNP using a Proxy Binding Acknowledgment (PBA). When the MAG-A X2 receives the PBA, encapsulated information is generated so as to enable a packet received from the terminal X1 to be transmitted to the LMA X3. Thereafter, by the MAG-A X2 transmitting a router advertisement in which the HNP is described, to the terminal X1, the terminal X1 can receive the HNP. The terminal X1 obtains its own IP address by, for example, StateLess Address Auto Configuration (SLAAC) or DHCP. When the terminal X1 establishes a link with the MAG-B X2 by a handover, the MAG-B X2 transmits the PBU in order to notify the LMA X3 of the location information of the terminal X1. On receiving the PBU, the LMA X3 updates the location information of the terminal X1, and updates the tunnel information. Then the LMA X3 transmits the PBA to the MAG-B X2 as a reception confirmation response.

Next, referring to FIG. 22, a description is given concerning communication between the terminal X1 and the server A X4. When the terminal X1 transmits a packet to the server A X4, and the MAG-A X2 receives the packet, encapsulation is performed with a transmission source IP address as MAG-A X2 and a destination IP address as LMA X3, and the packet is transmitted. On receiving the packet, the LMA X3 performs decapsulation, and transmits the packet to the server A X4. On the other hand, when the server A X4 transmits a packet to the terminal X1 and the LMA X3 receives the packet, location information is accessed in order to confirm the location of the terminal X1 (under which MAG is the terminal present?). Then, in order that the packet reaches the MAG destination under which the terminal X1 is present, the LMA X3 transmits the packet with the transmission source IP address as LMA X3, and the destination IP address as MAG-A X2. On receiving the packet, the MAG-A X2 performs decapsulation, and forwards the packet to the terminal X1.

Even if the terminal 1 moves to under a different MAG, as described above, since the LMA X3 comprehends the location of the terminal, the packet having the terminal as a destination arrives by going through the LMA X3.

Patent Literature 1 discloses a communication system where it is possible to reflect the state of a path between a terminal and a gateway in configuring a gateway address. The literature has a description of a communication apparatus (a wireless LAN base station) of the communication system provided with: information collection means for collecting information of a path to be used between the communication apparatus itself and a connection apparatus that connects a network to which the communication apparatus belongs and another network that differs from this network, and information of the connection apparatus; storage means for storing the collected path information and the information of the connection apparatus; selection means for selecting a connection apparatus based on the stored path information and the information of the connection apparatus, with respect to a communication apparatus that does not possess a path control function within a network; and path control means for controlling a path to the selected connection apparatus.

### CITATION LIST

### Patent Literature

### [PTL 1]

Japanese Patent Kokai Publication No. JP2005-236767A

### Non Patent Literature

### [NPL 1]

### C. Perkins, “IP Mobility Support for IPv4”, RFC3344.

### [NPL 2]

### S. Gundavelli, “Proxy Mobile IPv6”, RFC5213.

### SUMMARY

### Technical Problem

The following analysis is given by the present disclosure. In the technology described above, in a network X6 (PMIPv6 domain), a single LMA X3 controls communication between a terminal X1 and an external network. Since the single LMA X3 controls the PMIPv6 domain, in a case where the terminal X1 is present at a location distant from the LMA X3, a communication path for the terminal X1 to access the LMA X3 via MAG-A MAG-B X2 is longer than from a terminal that is adjacent to the LMA X3. In the example of FIG. 20, in a case where the terminal X1 moves from MAG-A X2, which is close to the LMA X3, to the MAG-B X2, which is at a location distant from the LMA X3, a communication path between the LMA X3 and the MAG-B X2 is lengthy. In this way, in the technology described above there is a problem in that a lengthy communication path occurs within a mobile IP domain, accompanying movement of the terminal X1.

With regard to this point, a communication system is disclosed in Patent Literature 1, where, for a communication apparatus (for example, a wireless LAN terminal) that does not have a path control function within a network, a communication apparatus (wireless LAN base station) is provided with selection means for selecting a connection apparatus (gateway) based on stored path information and information of connection apparatuses (gateways), and path control means for controlling a path to the selected connection apparatus (gateway). However, the path information in this literature stops at describing a path between the communication apparatus (for example, the wireless base station) and the connection apparatus (the gateway), and that it is possible to perform packet forwarding between gateways for downstream packets, or to select an optimal gateway for a router.

Thus there is a need in the art to provide a communication system, a gateway control apparatus, a path control apparatus, a communication method and a program, wherein it is possible to contribute to optimize upstream and downstream communication paths in a configuration where a plurality of gateways are arranged between different networks.

### Solution to Problem

According to a first aspect of the present disclosure, there is provided a communication system, including: a plurality of gateway apparatuses that connect a first network and a second network; and a gateway control apparatus that selects at least one of the plurality of gateway apparatuses, based on information related to location in the second network of a terminal that communicates with the first network via at least one of the plurality of gateway apparatuses. The system further includes path control means (entity) for controlling the first network so that a packet(s) having the terminal as a destination passes through the selected gateway apparatus(es).

According to a second aspect of the present disclosure, there is provided a gateway control apparatus, that selects at least one of a plurality of gateway apparatuses, based on information related to location of a terminal that communicates with a first network, in a second network, via at least one of the plurality of gateway apparatuses that connect the first network and the second network.

According to a third aspect of the present disclosure, there is provided a path control apparatus, that is connected to the gateway control apparatus as mentioned above, and that controls the first network so that a packet(s) having the terminal as a destination passes through the selected gateway apparatus(es).

According to a fourth aspect of the present disclosure, there is provided a communication method, comprising: a step of selecting at least one of a plurality of gateway apparatuses, based on information related to location of a terminal that communicates with a first network, in a second network, via at least one of the plurality of gateway apparatuses that connect the first network and the second network; and a step of controlling the first network so that a packet(s) having the terminal as a destination passes through the selected gateway apparatus(es). This method is associated with a particular mechanism known as a gateway control apparatus(es) that selects at least one from a plurality of gateway apparatuses that connect a first network and a second network.

According to a fifth aspect of the present disclosure, there is provided a program that executes on a computer connected to either of a first or second network: a process of selecting at least one of a plurality of gateway apparatuses, based on information related to location of a terminal that communicates with a first network, in a second network, via at least one of the plurality of gateway apparatuses that connect the first network and the second network; and a process of controlling the first network so that a packet(s) having the terminal as a destination passes through the selected gateway apparatus(es). It is to be noted that this program may be recorded on a computer-readable storage medium which may be non-transitory. That is, the present disclosure may be embodied as a computer program product.

### Advantageous Effects of Invention

According to the present disclosure, it is possible to contribute to optimize upstream and downstream communication paths in a configuration where a plurality of gateways are arranged among different networks.

### BRIEF DESCRIPTION OF DRAWINGS

FIG. 1 is a diagram showing a configuration example of an exemplary embodiment of the present disclosure.

FIG. 2 is a diagram showing a configuration example of a communication system of a first exemplary embodiment of the present disclosure.

FIG. 3 is a diagram showing a configuration example of a gateway control apparatus of the first exemplary embodiment of the present disclosure.

FIG. 4 is a diagram showing a configuration example of a location information DB of the gateway control apparatus of the first exemplary embodiment of the present disclosure.

FIG. 5 is a diagram showing a configuration example of a local gateway apparatus of the first exemplary embodiment of the present disclosure.

FIG. 6 is a diagram showing a configuration example of a connection management DB of the first exemplary embodiment of the present disclosure.

FIG. 7 is a diagram showing a configuration example of a gateway apparatus of the first exemplary embodiment of the present disclosure.

FIG. 8 is a diagram showing a configuration example of a location information DB of the gateway apparatus of the first exemplary embodiment.

FIG. 9 is a diagram describing an operational example of a path control unit provided in the gateway apparatus of the first exemplary embodiment of the present disclosure.

FIG. 10 is a sequence diagram describing an operational example of the first exemplary embodiment of the present disclosure.

FIG. 11 is a diagram showing an example of a communication system of a second exemplary embodiment of the present disclosure.

FIG. 12 is a diagram describing OpenFlow.

FIG. 13 is a diagram showing a flow entry in OpenFlow.

FIG. 14 is a diagram showing a configuration example of a control apparatus of the second exemplary embodiment of the present disclosure.

FIG. 15 is a diagram showing an operational example of the control apparatus of the second exemplary embodiment of the present disclosure.

FIG. 16 is a diagram showing a configuration example of a third exemplary embodiment of the present disclosure.

FIG. 17 is a diagram showing a configuration example of a gateway control apparatus in the third exemplary embodiment of the present disclosure.

FIG. 18 is a diagram showing a configuration example of a policy DB in the third exemplary embodiment of the present disclosure.

FIG. 19 is a diagram showing an operational example of the third exemplary embodiment of the present disclosure.

FIG. 20 is a diagram showing a communication system configuration example with regard to PMIPv6.

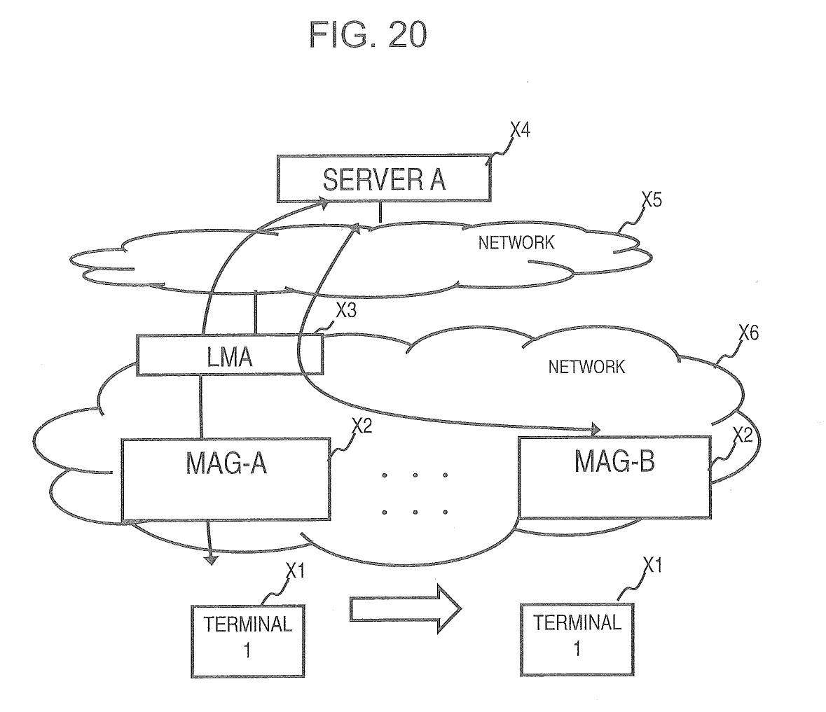

FIG. 21 is a sequence diagram showing an example of exchange of control messages of the communication system with regard to PMIPv6.

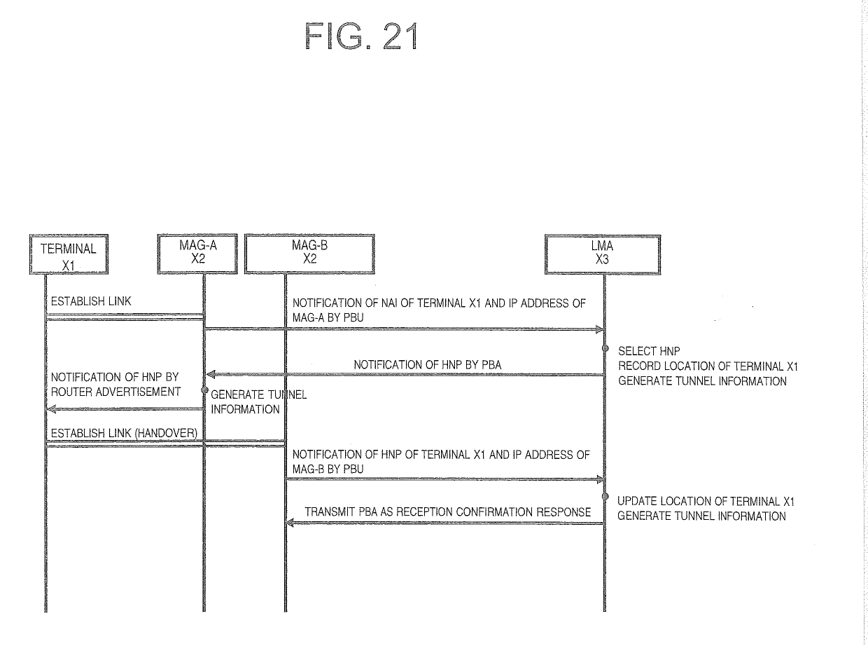

FIG. 22 is a sequence diagram showing an example of data communication of the communication system with regard to PMIPv6.

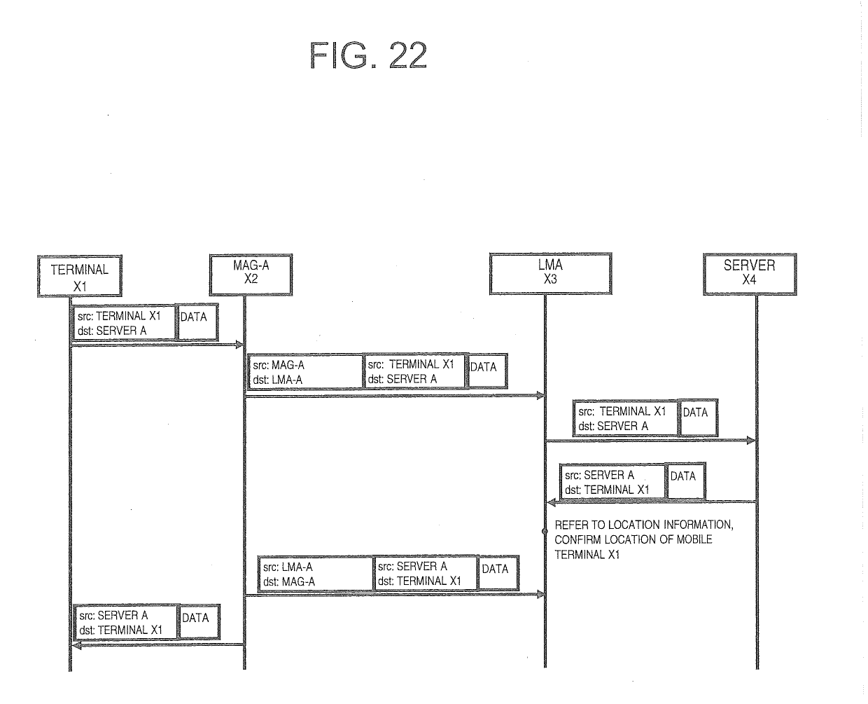

### MODES

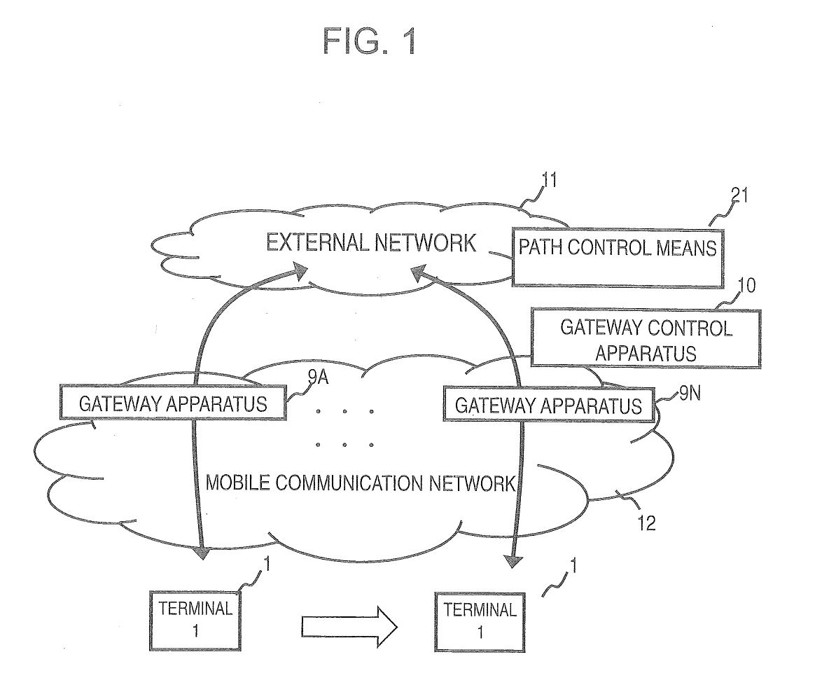

First, a description is given of an outline of an exemplary embodiment of the present disclosure, making reference to FIG. 1. Referring to FIG. 1, a mobile network 12 that communicates by using a tunnel formed according to technology such as a mobile IP protocol (MIPv4, MIPv6, PMIPv6, or the like), GPRS Tunneling Protocol (GTP) or the like, and an external network 11 (for example, the internet) are connected via gateway apparatuses 9A to 9N (where the gateway apparatuses 9A to 9N are not particularly distinguished, a description of “gateway apparatus/apparatuses 9” is used).

A plurality of the gateway apparatuses 9 are provided in the mobile communication network 12. The respective gateway apparatuses 9 form tunnels with a terminal 1, and control communication between the terminal 1 and the external network 11.

A gateway control apparatus 10 manages correspondence relationships between movement of the terminal 1 and the gateway apparatuses 9. Accompanying movement of the terminal 1 in the mobile communication network 12, the gateway control apparatus 10 selects a gateway apparatus (or apparatuses) 9 through which communication passes when the terminal 1 communicates with the external network 11, based on the location of the terminal 1. Therefore, in accordance with the location of the terminal 1, it is possible to avoid having a lengthy communication path in the mobile communication network 12.

The respective gateway apparatuses 9 and the gateway control apparatus 10 perform control so that communication between the terminal 1 and the external network 11 is continued even if the terminal 1 moves.

In the mobile communication network 12, a fixed address that does not change even when the terminal 1 moves and a location address that changes as the terminal 1 moves are assigned to the terminal 1. A communication partner that communicates with the terminal 1 uses a fixed address that does not change even when the terminal moves, when communicating with the terminal 1. In the mobile communication network 12, a packet transmitted/received between the gateway apparatus(es) 9 and the terminal 1 is encapsulated with a location address that depends on the location of the terminal 1.

In a case of receiving a packet transmitted from the terminal 1 with a destination of the external network 11, from the mobile communication network 12, the respective gateway apparatuses 9 perform decapsulation according to the location address and forward to the external network 11. In a case of receiving a packet(s) having the fixed address of the terminal 1 as a destination, from the external network 11, the respective gateway apparatuses 9 encapsulate the packet according to the location address and forward to the terminal 1. That is, by encapsulating and decapsulating a packet(s), the respective gateway apparatuses 9 establish a logical tunnel with the terminal 1.

As described above, the gateway control apparatus 10 selects a gateway apparatus(es) 9 where a non-lengthy path is realized based on the location of the terminal 1, from among the plurality of gateway apparatuses 9 present in the mobile communication network 12.

In addition, path control means (or entity) 21 of FIG. 1 controls the external network 11 so that a packet having the terminal 1 as a destination is forwarded to the gateway apparatus(es) 9 corresponding to the terminal 1. The path control means (entity) 21, for example, controls a forwarding path of the external network 11 so that a packet(s) having the terminal 1 as a destination is forwarded to the gateway apparatus(es) 9 corresponding to the terminal 1. The path control means (entity) 21, for example, notifies an apparatus of the external network 11 of the address of the gateway apparatus 9, as a transmission address of the packet having the terminal 1 as a destination. Furthermore, for example, the path control means (entity) 21 may instruct a packet(s) forwarding apparatus (switch or router) of the external network 11, so that the packet having the terminal 1 as a destination is forwarded to the gateway apparatus 9.

It is to be noted that the path control means (entity) 21 may be a logical entity implemented by software. That is, in the communication system of FIG. 1, the path control means (entity) 21 can operate in various physical entities, such as packet forwarding apparatuses forming the gateway apparatus 9, the gateway control apparatus 10, and the external network 11.

The path control means (entity) 21, for example, may control a switch or router of the external network 11 so that a packet having the fixed address of the terminal 1 as a destination is forwarded to the address of the gateway apparatus 9 corresponding to the terminal 1. For example, the path control apparatus 21 may control the switch or router by changing a routing table of a switch or router of the external network 11.

In this way, with respect to the external network 11 also, it is possible to forward a packet(s) having the terminal 1 as a destination to the gateway apparatus(es) 9 corresponding to the terminal 1.

It is to be understood that operation of the path control means (entity) 21 is not limited the abovementioned operations, and includes every type of transformation and modification that a person skilled in the art can realize, in accordance with technological concepts thereof.

### First Exemplary Embodiment

Next, a detailed description is given concerning a first exemplary embodiment of the present disclosure in which path control means is implemented in a gateway apparatus(es) 9, making reference to the drawings.

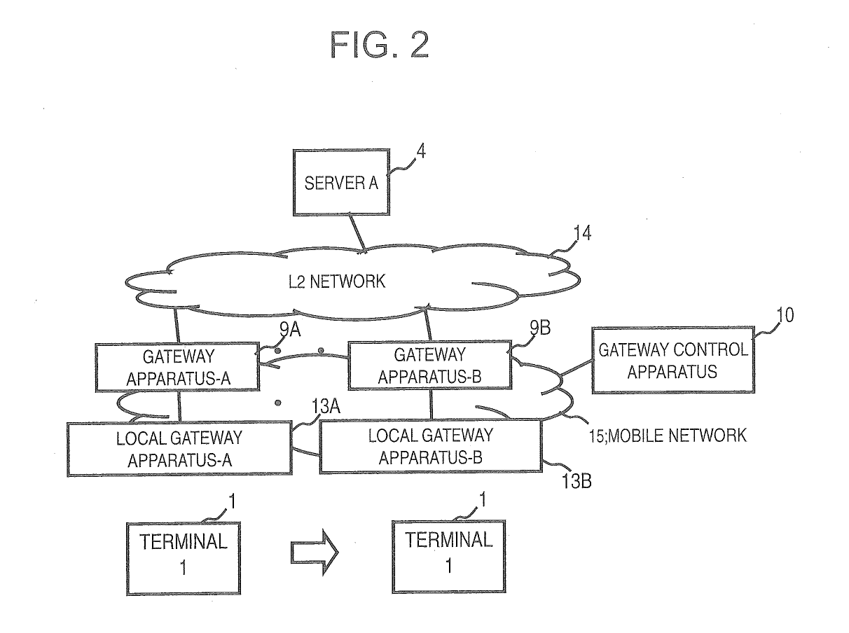

FIG. 2 is a diagram showing a configuration example of a communication system of the first exemplary embodiment of the present disclosure. Referring to FIG. 2, a terminal 1, a server A 4, an L2 network 14, and a mobile network 15 are shown. In addition, a plurality of gateway apparatuses 9, a gateway control apparatus 10, and a plurality of local gateway control apparatuses 13A and 13B (below, where the local gateway apparatuses 13A and 13B are not particularly distinguished, a description of “local gateway apparatus/apparatuses 13” is used) are arranged in the mobile network 15; note that in FIG. 2, only one terminal is shown for simplicity, but a plurality of terminals may be present under the control of the mobile network 15.

The terminal 1 communicates with the server A 4 of the L2 network 14 via a gateway 9.

A location identifier that changes along with movement and an inherent identifier that does not change with movement are assigned to the terminal 1. The location identifier, for example, is an IP address of the local gateway apparatus 13 to which the terminal 1 is connected, an IP address obtained from a DHCP (Dynamic Host Configuration Protocol) server of a network to which the terminal 1 is connected, or the like. A communication system may also be considered which has a configuration where functionality of the local gateway apparatus 13 is provided in the terminal 1, and the local gateway apparatus 13 is not present (for example, Client Mobile IP (CMIP)). In this case, the location identifier of the terminal 1 is an IP address obtained from the DHCP of a network to which the terminal 1 connects after each movement. The inherent identifier of the terminal 1 is, for example, an IP address assigned to the terminal 1, or a Home Network Prefix (HNP). In the present exemplary embodiment, a description is given where the inherent identifier is the IP address assigned to the terminal 1, and the location identifier is the IP address of the local gateway apparatus 13 to which the terminal 1 is connected.

The gateway control apparatus 10 selects a gateway apparatus (apparatuses) 9 through which communication passes when the terminal 1 communicates with the L2 network 14, based on the location of the terminal 1. For example, the gateway control apparatus(es) 10 switches the gateway apparatus(es) 9 when the terminal 1 moves and changes location. The location of the terminal 1, for example, is determined based on the local gateway apparatus 13 to which the terminal 1 is connected, that is, its location in the L2 network 14. The gateway control apparatus 10, for example, selects a gateway apparatus 9 from among the plurality of gateway apparatuses 9, based on the distance between the gateway apparatus 9 and the local gateway apparatus 13 to which the terminal 1 is connected.

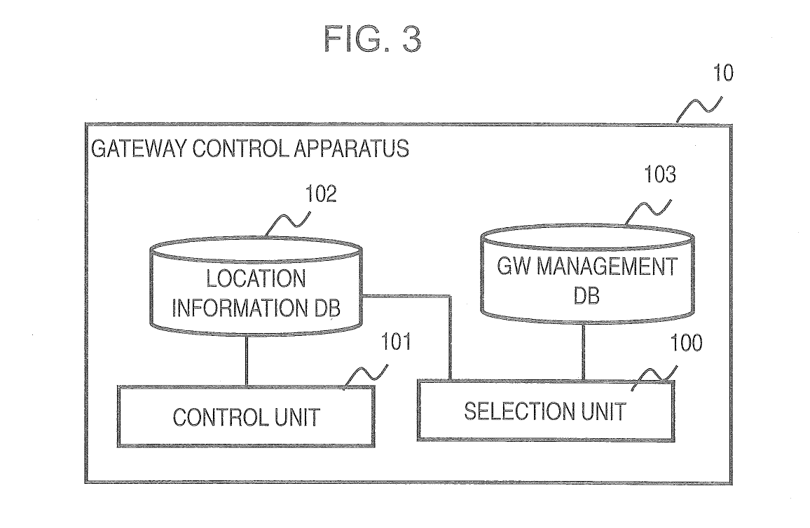

FIG. 3 is a diagram showing an example of a configuration of a gateway control apparatus 10 of the first exemplary embodiment of the present disclosure. Referring to FIG. 3, the gateway control apparatus includes a selection unit 100, a control unit 101, a location information database (location information DB) 102, and a gateway management database (GW management DB) 103.

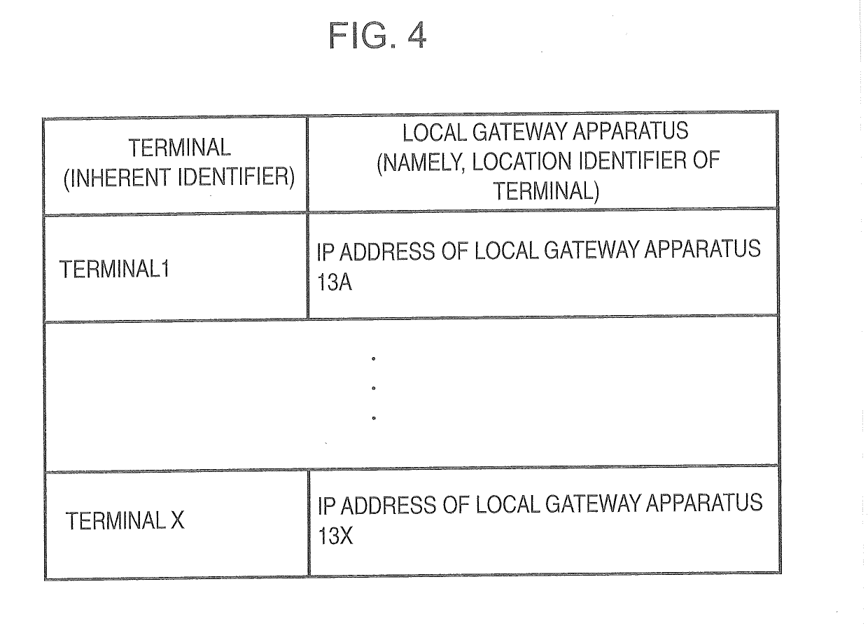

The control unit 101 receives the location identifier of the terminal 1 from the terminal 1 or the local gateway apparatus 13, to be stored in the location information DB 102. The location information DB 102, as shown in FIG. 4 for example, associates and manages the inherent identifier of the terminal 1 and the received location identifier (in the example of FIG. 4, the IP address of the local gateway apparatus 13 to which the terminal is connected).

In a case where, for example, the terminal 1 moves and handover is performed to another local gateway apparatus 13, the control unit 101 receives the location identifier from the terminal 1 or the local gateway apparatus 13. It is to be noted that in the present exemplary embodiment a description is given with an example where the location identifier is the IP address of the local gateway apparatus 13 to which the terminal 1 is connected.

The selection unit 100 selects corresponding gateway apparatuses 9, with regard to respective terminals connected to the mobile network 15. The selection unit 100 selects a gateway apparatus(es) 9 through which the terminal communicates with the L2 network 14, based on the location of the terminal connected to the mobile network 15. For example, the selection unit 100 refers to the location identifier of the terminal 1 stored in the location information DB 102, to select the gateway apparatus 9.

The selection unit 100 recognizes the location of the local gateway apparatus 13 to which the terminal 1 is connected, from the IP address of the local gateway apparatus 13, which is the location identifier. The selection unit 100, for example, recognizes a distance between the local gateway apparatus 13 and the gateway apparatus 9, based on the number of hops and RTT (Round Trip Time) between the local gateway apparatus 13 and the gateway apparatus 9. The selection unit 100, for example, selects a gateway apparatus 9 where the distance between the local gateway apparatus 13 and the gateway apparatus 9 is shortest. Furthermore, in addition to the location identifier of the terminal, the selection unit 100 may give consideration also to the distance from the gateway apparatus 9 to an apparatus (for example, the server A 4) on the L2 network 14, which is a communication partner of the terminal, to select the gateway apparatus 9. The selection unit 100, for example, recognizes the distance based on the number of hops and the RTT (Round Trip Time) between the gateway apparatus 9 and the L2 network 14.

The selection unit 100 may select the gateway apparatus 9 based on loads on the respective gateway apparatuses 9. The selection unit 100, for example, monitors the loads on the respective gateway apparatuses 9 by monitoring congestion states of traffic passing through the respective gateway apparatuses 9. The selection unit 100 may select the gateway apparatus 9 based on communication quality between the local gateway apparatus(es) 13 and the gateway apparatus(es) 9. The selection unit 100, for example, monitors packet loss rate between the local gateway apparatus 13 and the gateway apparatuses 9, and monitors communication quality.

The selection unit 100, for example, may make a selection combining a plurality of elements such as the number of hops between the local gateway apparatus 13 and the gateway apparatuses 9, and the loads on the gateway apparatuses 9. The combination of a plurality of elements is not limited to the combination described above. Also, the number of the local gateway apparatus(es) or gateway apparatus(es) located on a path depicted in FIG. 2 is not limited to the illustrated “one” which is merely shown for simplified schematic illustration.

The selection unit 100 stores a correspondence relationship (on a selected path) between the selected gateway apparatus 9 and the terminal 1, in the GW management DB 103. The selection unit 100 notifies the local gateway apparatus 13 of the correspondence relationship between the selected gateway apparatus 9 and the terminal 1. The control unit 101 notifies respective selected gateway apparatuses 9 of correspondence relationships between terminals corresponding to the selected gateway apparatuses 9 and the local gateway apparatuses 13 to which the terminals are connected.

The local gateway apparatus 13 assumes a role of a gateway for the terminal 1 to access the mobile network 15.

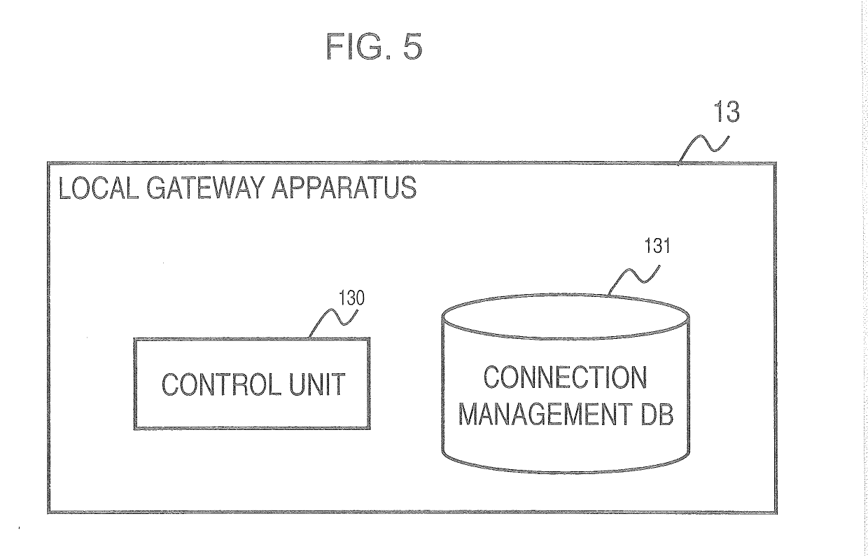

FIG. 5 shows a configuration example of the local gateway apparatus 13 of the first exemplary embodiment of the present disclosure. The local gateway apparatus 13 includes the control unit 130 and the connection management database (connection management DB) 131.

The local gateway apparatus 13 communicates with the gateway apparatus 9 instead (in place) of the terminal 1. Specifically, the control unit 130 receives a correspondence relationship between the terminal 1 and the gateway apparatus 9, from the gateway control apparatus 10, and stores the relationship in the connection management DB 131. That is, by referring to the connection management DB 131, the local gateway apparatus 13 recognizes the gateway apparatus 9 that is to forward the traffic of the terminal to which the local gateway apparatus 13 itself is connected.

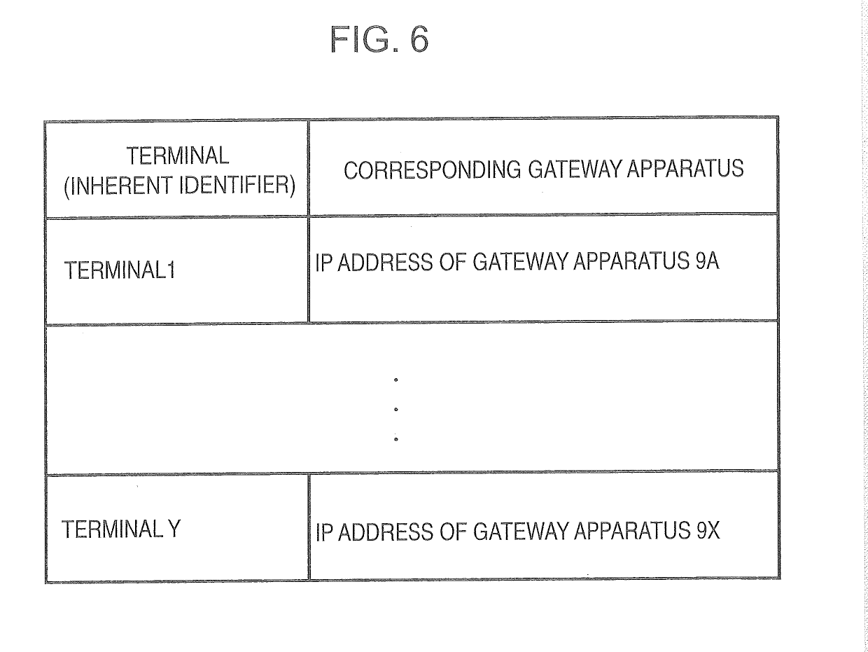

FIG. 6 shows a configuration example (table) of the connection management DB 131. In the example of FIG. 6, the inherent identifier of the terminal 1 and the IP address of the gateway apparatus 9 are associated and stored.

In a case where the terminal 1 communicates with the L2 network 14, the control unit 130 refers to the connection management DB 131 to encapsulate/decapsulate packet(s) transmitted/received between the terminal 1 and the gateway apparatus 9 selected by the gateway control apparatus 10.

In a case where, for example, the terminal 1 transmits a packet having the L2 network 14 as a destination, the control unit 130 performs encapsulation such that the transmission source of the packet is the local gateway apparatus 13, and the destination is the gateway apparatus 9 (the gateway apparatus 9 corresponding to the terminal 1). That is, the control unit 130 forms a logical tunnel between the local gateway apparatus 13 to which the terminal 1 is connected, and the gateway apparatus 9 selected by the gateway control apparatus 10 for the terminal 1.

On receiving a packet from the gateway apparatus 9, the packet being encapsulated so as to have the gateway apparatus 9 as a transmission source and the local gateway apparatus 13 as a destination, for example, the control unit 130 decapsulates the packet. The control unit 130 refers to the destination address of the packet after decapsulation, and transmits the packet to a terminal corresponding to the destination address.

The gateway apparatus 9 functions as a gateway for communication between the L2 network 14 and a terminal of the mobile network 15.

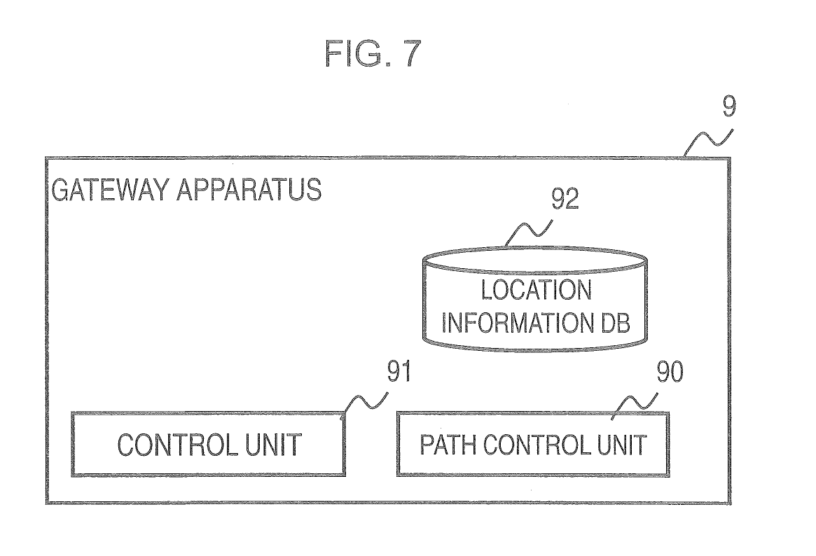

FIG. 7 shows a configuration example of the gateway apparatus 9 of the first exemplary embodiment of the present disclosure. The gateway apparatus 9 includes a path control unit 90, a control unit 91, and a location information database (location information DB) 92.

The control unit 91 receives correspondence relationships between terminals that communicate with the L2 network 14 via the control unit's own gateway apparatus 9, and the local gateway apparatus 13 to which the respective terminals are connected, from the gateway control apparatus 10. The control unit 91 stores the received information in the location information DB 92.

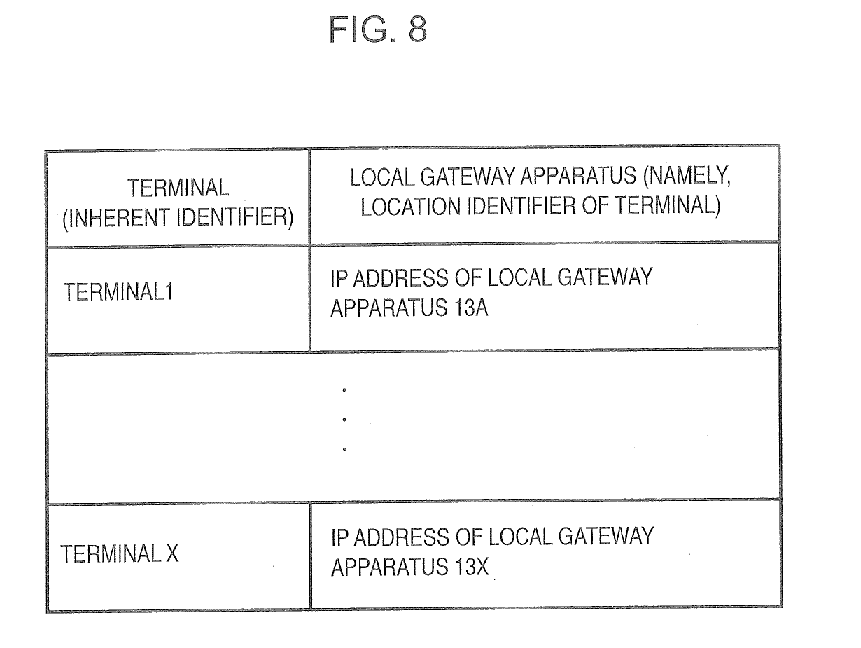

FIG. 8 shows a configuration example (table) of the location information DB 92. In the example of FIG. 8, the inherent identifier of the terminal 1 and the IP address of the local gateway apparatus 13 are associated and stored.

The control unit 91 refers to the location information DB 92, to encapsulate/decapsulate packet(s) transmitted/received between the local gateway apparatus 13 and the gateway apparatus 9.

The control unit 91, for example, decapsulates a packet that has been transmitted to the gateway apparatus 9, the packet having been encapsulated by the local gateway apparatus 13, and transmits the packet to the L2 network 14. In a case where the decapsulated packet is forwarded to the L2 network 14, the control unit 91 assigns an L2 header (a header with destination and transmission source as MAC addresses) and transmits. For example, where a packet is transmitted to the server A 4, a header is assigned with the MAC address of the server A 4 as a destination. The control unit 91 recognizes the MAC address of the server A 4 in advance, by ARP (Address Resolution Protocol). It is to be noted that in a case of forwarding the decapsulated packet to the L2 network 14, the control unit 91 stores the MAC address of its own gateway apparatus 9 in the transmission source of the L2 header. That is, the gateway apparatus 9 communicates with the L2 network 14 as a proxy for the terminal 1.

The control unit 91 encapsulates a packet received from the L2 network 14 to have the local gateway apparatus 13 as a destination, and transmits the packet to the local gateway apparatus 13. It is to be noted that, in a case of receiving a packet from the L2 network, the control unit 91 refers to the location information DB 92 and performs encapsulation having as a destination the local gateway apparatus 13 to which a terminal corresponding to the destination IP address of the received packet is connected.

The path control unit 90 has a function corresponding to path control means (entity) 21 of FIG. 1. That is, in the first exemplary embodiment, the gateway apparatus 9 is provided with a function entity equivalent to the path control means (entity) 21.

Due to the terminal 1 moving, the gateway control apparatus 10 switches over the gateway apparatus(es) 9 through which communication from the terminal 1 passes to the L2 network.

In a case of transmitting a packet to the terminal 1, an apparatus in the L2 network 14 that performs communication with the terminal 1 transmits the packet with a destination of the MAC address of the gateway apparatus 9 that corresponds to the terminal 1. This is because, since the gateway apparatus 9 communicates as a proxy for the terminal 1, the gateway apparatus 9 is seen as a pseudo terminal 1 from an apparatus on the L2 network side.

Due to the terminal 1 moving, when the gateway apparatus 9 switches over, an apparatus present on the L2 network 14 (for example, a server A 4) must switch over the destination MAC address of a packet to be transmitted to the terminal 1.

The path control unit 90 has a function to change the destination MAC address of the packet to be transmitted to the terminal 1, in an apparatus on the L2 network.

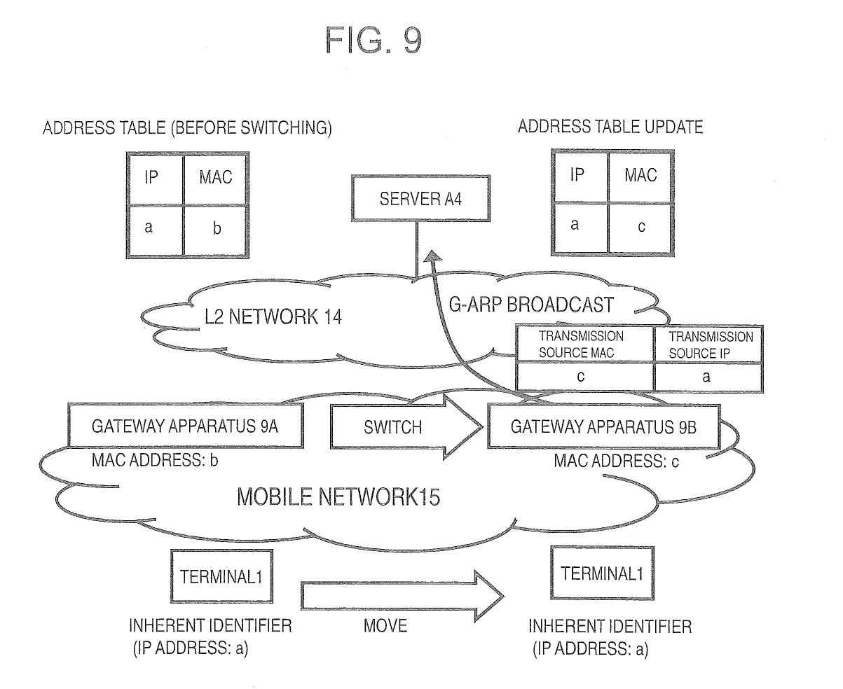

Next, referring to FIG. 9, a description is given of an operational example of the path control unit 90. The server A 4 of the L2 network 14 communicates with the terminal 1 via a gateway apparatus 9A. The server A 4 has an address table that stores a correspondence between a destination IP address of the terminal 1 and a MAC address corresponding to this IP address. By receiving a packet having the server A 4 as a destination from the terminal 1, the server A 4 stores a MAC address of the gateway apparatus 9A as a MAC address corresponding to the IP address of the terminal 1, in the address table. In the example of FIG. 9, the IP address of the terminal 1 is a, and the MAC address of the gateway apparatus 9A is b.

Due to the terminal 1 moving, the gateway control apparatus 10 switches over from the gateway apparatus 9A to the gateway apparatus 9B. For example, in order to make an apparatus in the L2 network 14 recognize a MAC address (the MAC address of the gateway apparatus 9B) that is a forwarding destination of a packet to the IP address of the terminal 1, the path control unit 90 broadcasts a Gratuitous ARP (below, GARP). The GARP is an ARP packet, and is used when an IP address is assigned to a host, to confirm whether or not another host already has the same IP address. The path control unit 90 utilizes the GARP (for ARP), in order to make an apparatus on the L2 network 14 recognize the MAC address of the gateway apparatus 9 after switching.

As shown in FIG. 9, the IP address of the terminal 1 and the MAC address of the gateway apparatus 9 are stored in the GARP. By broadcasting a GARP packet, the path control unit 90 transmits the GARP packet to an apparatus on the L2 network. The apparatus (namely, the server A 4) that receives the GARP packet changes a MAC address corresponding to the IP address a of the terminal 1, changing from the MAC address b of the gateway apparatus 9A to a MAC address c of the gateway apparatus 9B.

It is to be noted that respective parts or elements (processing means) of the gateway control apparatus 10, the local gateway apparatus 13, and the gateway apparatus 9 shown in the respective drawings described above can also be implemented by a computer program that executes the abovementioned respective processes in a computer configured from these apparatuses using software thereof.

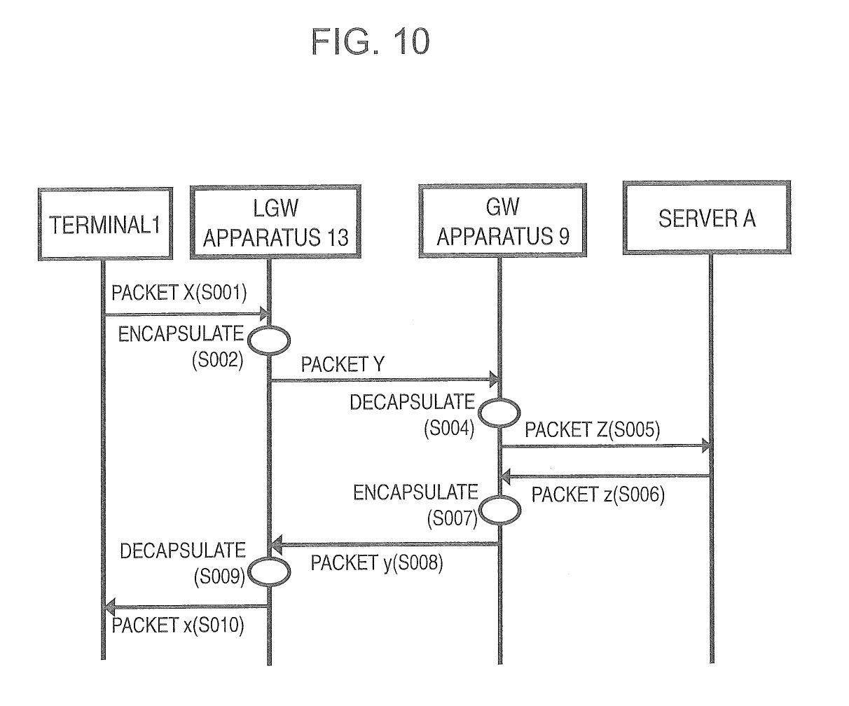

Next, referring to FIG. 10, a description is given of an operational example of the first exemplary embodiment. FIG. 10 is a sequence diagram representing an operation in which the terminal 1 communicates with the server A 4 of the L2 network 14, via a local gateway apparatus (LGW apparatus) 13 and a gateway apparatus (GW apparatus) 9.

The terminal 1 transmits a packet (packet X) having the IP address of the server A 4 as a destination and the IP address of the terminal 1 as a transmission source, to the local gateway apparatus 13 (step S001).

The local gateway apparatus 13 encapsulates the packet X with the IP address of the gateway apparatus 9 and the IP address of the local gateway apparatus, to generate a packet Y (step S002). The packet Y has the IP address of the gateway apparatus 9 as a destination, and the IP address of the local gateway apparatus 13 as a source. The local gateway apparatus 13 transmits the generated packet Y to the gateway apparatus 9 (step S003).

The gateway apparatus 9 decapsulates the encapsulated packet Y (step S004). The gateway apparatus 9 transmits a packet Z obtained by adding an L2 header to the decapsulated packet, to the L2 network 14 (step S005). The L2 header has a MAC address of the server A 4 as a destination and a MAC address of the gateway apparatus 9 as a transmission source. The gateway apparatus 9 recognizes the MAC address of the server A 4 in advance, by an ARP.

From the above, the packet Z reaches the server A 4, and the server A 4 transmits the packet z as a response (step S006).

The gateway apparatus 9 receives the packet z having the terminal 1 as a destination, from the server A 4. The packet z is an L2 packet having the MAC address of the server A 4 as a transmission source, and the MAC address of the gateway apparatus 9 as a destination. It is to be noted that the destination IP address of the packet z is the IP address of the terminal 1. The gateway apparatus 9 removes the L2 header of the packet z, and encapsulates the packet (step S007). The gateway apparatus 9 generates a packet y by encapsulation. The packet y has the IP address of the local gateway apparatus 13 as a destination, and the IP address of the gateway apparatus 9 as a transmission source. The gateway apparatus 9 transmits the generated packet y to the local gateway apparatus 13 (step S008).

The local gateway apparatus 13 decapsulates the packet y, and generates a packet x (step S009). The local gateway apparatus 13 transmits the packet x to the terminal 1 (step S010). The decapsulated packet has the IP address of the terminal 1 as a destination and the IP address of the server A 4 as a transmission source.

Communication between the terminal 1 and the server A 4 is realized by the above operations. A communication path at this time is optimized in accordance with the location of the terminal 1, as shown in FIG. 9.

### Second Exemplary Embodiment

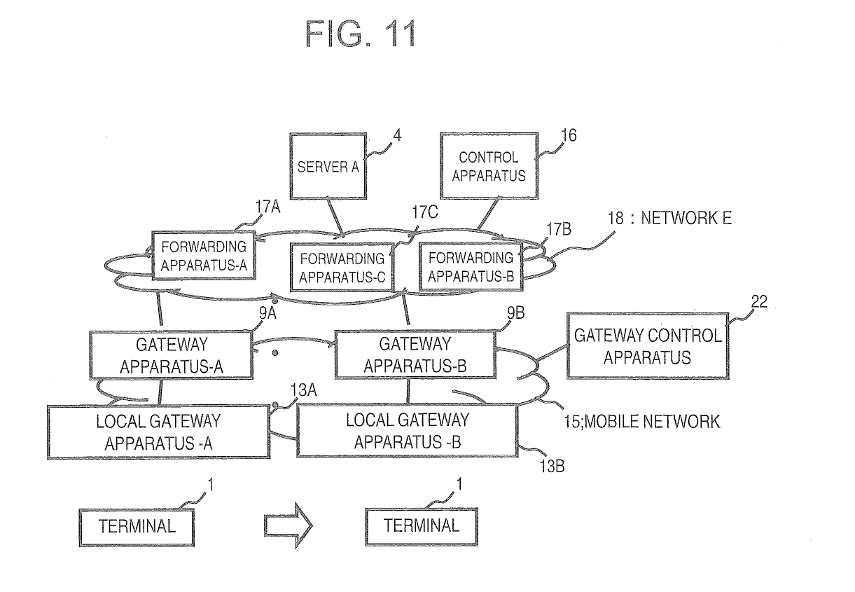

Next, a description is given concerning a second exemplary embodiment of the present disclosure, in which an apparatus that centrally controls a first network is arranged as path control means (entity) 21. FIG. 11 is a diagram showing an example of a communication system of the second exemplary embodiment of the present disclosure.

Referring to FIG. 11, a terminal 1, a network E 18, and a mobile network 15 are shown. Forwarding apparatuses 17A, 17B, and 17C (below, where the forwarding apparatuses 17A, 17B, and 17C are not particularly distinguished, a term of “forwarding apparatus 17” as a singular form is used for simplicity of elucidation, which also represents a plural form), a control apparatus 16, and a server A 4 are arranged in the network E 18. Gateway apparatuses 9, local gateway apparatuses 13, and a gateway control apparatus 22 are arranged in the mobile network 15.

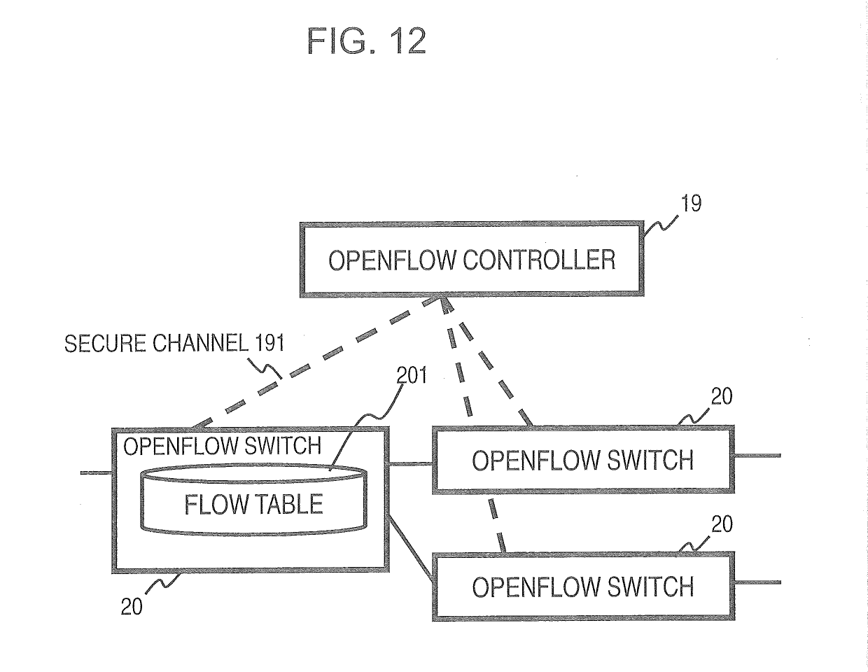

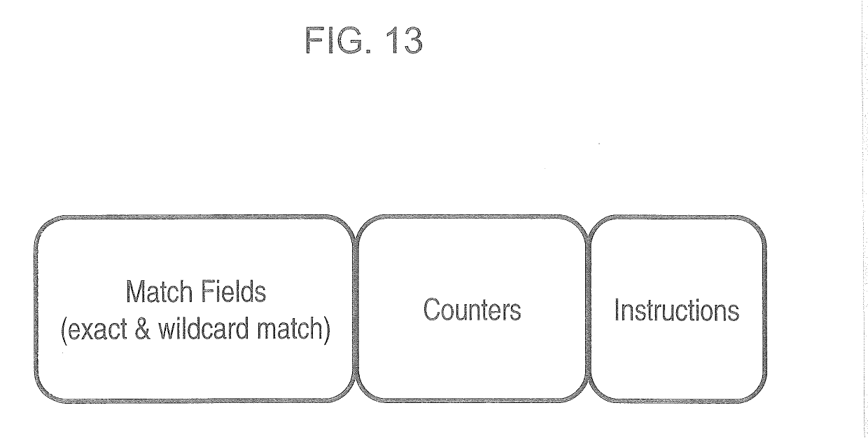

First, a description is given concerning OpenFlow technology, using FIG. 12 and FIG. 13. In OpenFlow, communication is taken as end-to-end flow, and path control, failure recover, load balancing, and the like are performed on a per-flow basis. FIG. 12 shows an outline of a communication system configured according to the OpenFlow technology. It is to be noted that a flow is a sequence of communication packet groups having a prescribed attribute. An OpenFlow switch 20 is a network switch that uses the OpenFlow technology. An OpenFlow controller 19 is an information processing apparatus that controls the OpenFlow switch(es) 20.

The OpenFlow switch 20 communicates with the OpenFlow controller via a secure channel 191 configured between the OpenFlow controller 19 and the OpenFlow switch(es) 20. The OpenFlow controller 19 performs configuration of a flow table 201 of the OpenFlow switch 20 via the secure channel 191. It is to be noted that the secure channel 191 is a communication path in which a measure is taken to prevent interception or falsification of communication between the switch and controller.

FIG. 13 is a configuration example of respective entries (flow entries) of the flow table 201. A flow entry is configured by Match Fields for matching information (for example, destination IP address, VLAN ID, or the like) included in a header of a packet received by the switch, Counters, being statistical information for respective packet flows, and Instructions that specify a processing method for a packet matching a matching rule.

On receiving a packet, the OpenFlow switch 20 refers to the flow table 201. The OpenFlow switch 20 searches for a flow entry having matching rules (Match Fields) that match the header information of a received packet. In a case where a flow entry matching the header information of the received packet is retrieved, the OpenFlow switch 20 processes the received packet in accordance with a processing method defined in an instruction field of the retrieved entry. The processing method, for example, defines “forward a received packet from a prescribed port”, “drop a received packet”, or “rewrite part of the header of a received packet and forward from a prescribed port”.

On the other hand, in a case where a flow entry matching the header information of the received packet is not found, the OpenFlow switch 20, for example, forwards the received packet to the OpenFlow controller 19, via the secure channel 191. By forwarding the received packet, the OpenFlow switch 20 requests the controller to configure a flow entry specifying a processing method of the received packet.

The OpenFlow controller 19 determines a processing method for the received packet, and configures a flow entry including the determined processing method, in the flow table 201. Thereafter, the OpenFlow switch 20 processes subsequent packets belonging to the same flow as the received packet, according to the configured flow entry.

The forwarding apparatus 17 of FIG. 11 includes a function that is equivalent to the OpenFlow switch 20. The network E 18 is a communication network that includes at least some of the forwarding apparatuses 17.

The control apparatus 16 includes a function that is equivalent to the OpenFlow controller 19. In the present exemplary embodiment, the control apparatus 16 operates as the path control means (entity) 21 of FIG. 1, and is provided with means adapted to communicate with the gateway control apparatus 10.

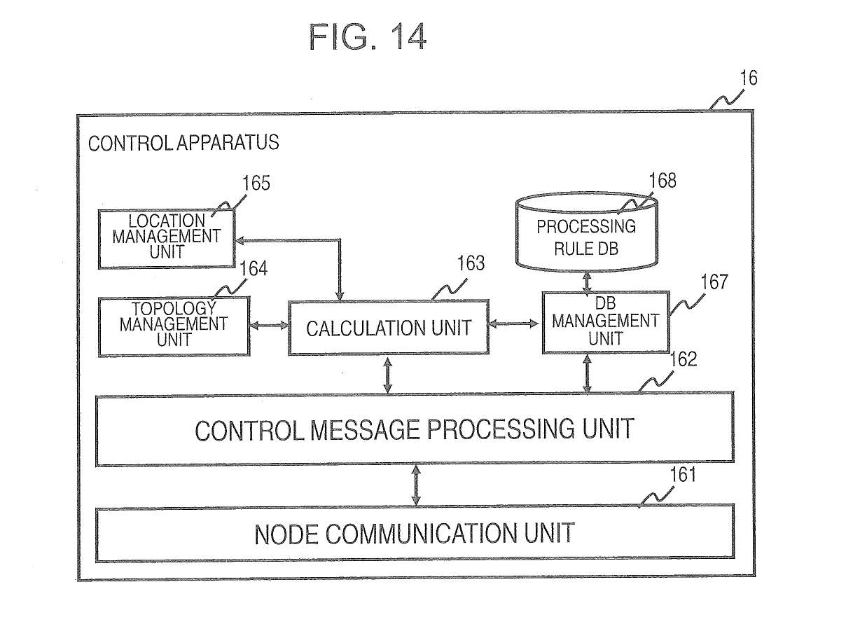

FIG. 14 shows a configuration example of the control apparatus 16. FIG. 14 is an example, and the configuration of the control apparatus 16 is not limited to the example of FIG. 14.

A processing rule database (processing rule DB) 168 stores a packet processing rule for configuring in the forwarding apparatus 17. It is to be noted that the configuration of the packet processing rule is the same as the configuration of the flow entry shown in FIG. 13.

A node communication unit 161 communicates with the forwarding apparatus 17 and the gateway control apparatus 22. A control message processing unit 162 transmits a control message received via the node communication unit 161 to a calculation unit 163 and a DB management unit 167 of the control apparatus 16, and also transmits a packet processing rule generated by the calculation unit 163 to the forwarding apparatus 17 via the node communication unit 161.

A topology management unit 164 manages network topology, based on connection relationships of the forwarding apparatus 17 collected via the node communication unit 161 and information of the terminal 1 and the gateway apparatus 9 to which the terminal 1 is connected, from the gateway control apparatus 22. For example, the managed network topology is a piece of topology information of the network E 18 and connection relationships of apparatuses connected to the network E 18, for example, the gateway apparatuses 9. When a gateway apparatus 9 corresponding to the terminal 1 is switched over by a handover of the terminal 1, the topology management unit 164 receives an inherent identifier of the terminal 1 and an identifier (IP address, MAC address, or the like) of the gateway apparatus 9 corresponding to the terminal 1, from the gateway control apparatus 22. Based on this information, the topology management unit 164 updates the topology information.

A location management unit 165 performs management as to which forwarding apparatus present in the network E 18 a gateway apparatus 9, which is passed through when the terminal 1 accesses the network E 18, is under the control of.

The calculation unit 163 determines a forwarding path of a packet based on the network topology, and packet processing to be executed in a forwarding apparatus 17 in the forwarding path. That is, the calculation unit 163 calculates a forwarding path of the packet, and determines a packet processing rule corresponding to the forwarding path. The calculation unit 163 fulfills a role equivalent to the path control means (entity) 21. When the gateway apparatus 9 passed through by a handover or the like is switched, the calculation unit 163 obtains a forwarding apparatus 17 connected to this gateway apparatus 9 from the topology management unit 164. The calculation unit 163 records the inherent identifier of the terminal 1 and an identifier of the forwarding apparatus 17 connected to the gateway apparatus 9 corresponding to the terminal 1, as a set, in the location management unit 165. Thereafter, the calculation unit 163 accesses the topology management unit 164 and the location management unit 165, confirms the topology information and the location of the terminal, and determines a forwarding path of a packet having the terminal 1 as a destination.

The calculation unit 163 confirms the forwarding apparatus 17 to which a gateway apparatus corresponding to the terminal 1 is connected by accessing the location management unit 165, and the calculation unit 163 calculates a forwarding path as far as the forwarding apparatus 17 and determines a packet processing rule corresponding to the calculated forwarding path. The calculation unit 163 notifies the forwarding apparatus 17 in the forwarding path of the packet, of the determined packet processing rule. The packet processing rule determined by the calculation unit 163 is also transmitted to the DB management unit 167 and is reflected in the processing rule DB 168.

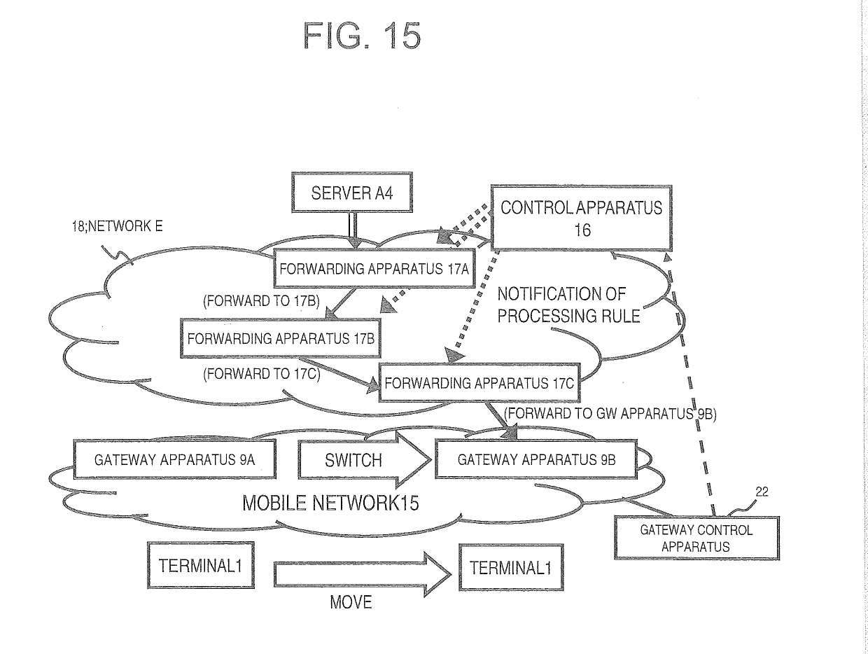

Next, referring to FIG. 15, a description is given of an operation of configuring a forwarding path by the control apparatus 16. The gateway control apparatus 22 notifies the control apparatus 16 that a gateway apparatus has switched from the gateway apparatus 9A to the gateway apparatus 9B by a handover of the terminal 1.

The control apparatus 16 controls the forwarding apparatus 17 of the network E 18 so that a packet having the terminal 1 as a destination is forwarded to the gateway apparatus 9B after switching.

Specifically, the calculation unit 163 recognizes that the forwarding apparatus that is connected to the gateway apparatus 9 after switching is the forwarding apparatus 17C. The calculation unit 163 calculates a path by which the packet having the terminal 1 as a destination is forwarded to the forwarding apparatus 17C. In the example of FIG. 15, the calculation unit 163 calculates a path by which a packet is forwarded in the order of forwarding apparatuses 17A, 17B, and 17C.

The calculation unit 163 determines a packet processing rule to be notified to each forwarding apparatus on the forwarding path. The calculation unit 163 notifies the forwarding apparatus 17A of a processing rule for forwarding the packet having the terminal 1 as a destination to the forwarding apparatus 17B. The calculation unit 163 notifies the forwarding apparatus 17B of a processing rule for forwarding the packet having the terminal 1 as a destination to the forwarding apparatus 17C. The calculation unit 163 notifies the forwarding apparatus 17C of a processing rule for forwarding the packet having the terminal 1 as a destination to the forwarding apparatus 9B.

The DB management unit 167 records a packet processing rule determined by the calculation unit 163 in the processing rule DB 168. The DB management unit 167 transmits the packet processing rule to the forwarding apparatus 17, in response to a request to transmit the packet processing rule from the forwarding apparatus 17.

The control message processing unit 162 analyzes a control message (for example, a request to configure a packet processing rule) received from the forwarding apparatus 17, and performs processing corresponding to the control message. The control message processing unit 162 generates a message (for example, a message for configuring a packet processing rule) to be transmitted to the forwarding apparatus 17.

An apparatus in a mobile network 15 of the second exemplary embodiment is the same as an apparatus of the first exemplary embodiment. The gateway control apparatus 22 of the present exemplary embodiment communicates with the control apparatus 16.

It is to be noted that in the present exemplary embodiment, the gateway control apparatus 22 and the control apparatus 16 were described as different apparatuses, but the two apparatuses can also be implemented as one apparatus. That is, the functionality of the control apparatus 16 may be added to the gateway control apparatus 22, or a configuration in which the gateway control apparatus 22 controls the forwarding apparatus 17 may be used. A communication partner of the terminal 1 is not limited to a terminal within the network E 18 and, for example, a case is also possible where the network E 18 is connected to an external network, and the terminal 1 communicates with an apparatus of this external network via the network E 18.

As described above, according to the present exemplary embodiment it is possible to perform detailed control, in comparison with the first exemplary embodiment. A reason for this is that an OpenFlow mechanism is used in path control.

### Third Exemplary Embodiment

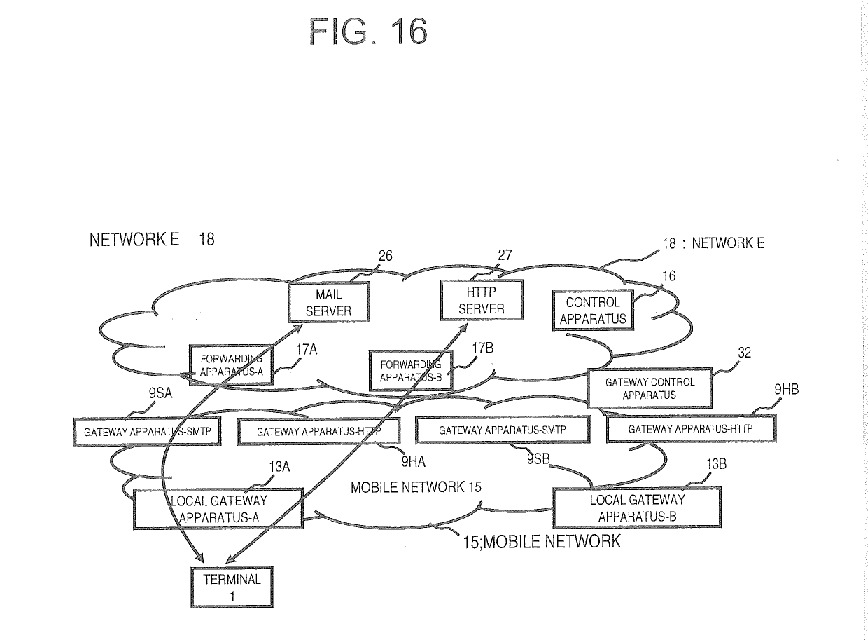

Next, a description is given concerning a third exemplary embodiment of the present disclosure in which a terminal 1 can simultaneously use a plurality of gateway apparatuses 9. FIG. 16 is a diagram showing a configuration example of a third exemplary embodiment of the present disclosure.

Referring to FIG. 16, a mail server 26, an HTTP (Hyper Text Transfer Protocol) server 27, a gateway apparatus-SMTP 9SA, a gateway apparatus-HTTP 9HA, a gateway apparatus-SMTP 9SB, a gateway apparatus-HTTP 9HB, a local gateway apparatus 13A, a local gateway apparatus 13B, a gateway control apparatus 32, a forwarding apparatus 17A, a forwarding apparatus 17B, and a control apparatus 16 are shown.

The gateway apparatus-HTTP 9HA and the gateway apparatus-HTTP 9HB are gateway apparatuses for HTML (Hyper Text Markup Language). The gateway apparatus-SMTP 9SA and the gateway apparatus-SMTP 9SB are gateway apparatuses 9 for email (SMTP; Simple Mail Transfer Protocol). In the present exemplary embodiment, it is possible to select a gateway apparatus to be used from among these gateways in accordance with purpose, and to use a plurality of gateway apparatuses 9 simultaneously. As a result, the gateway control apparatus 32, for example, performs an operation of selecting the gateway apparatus 9 for each communication flow (or each packet or each group of packets).

FIG. 16 shows a state in which the terminal 1 is connected to the local gateway apparatus 13A and is accessing a mobile network 15.

The gateway control apparatus 32 selects a gateway apparatus 9 to be used for each communication flow, based on a prescribed reference. The prescribed reference, for example, is the distance from the local gateway apparatus 13, or the load on a gateway apparatus 9.

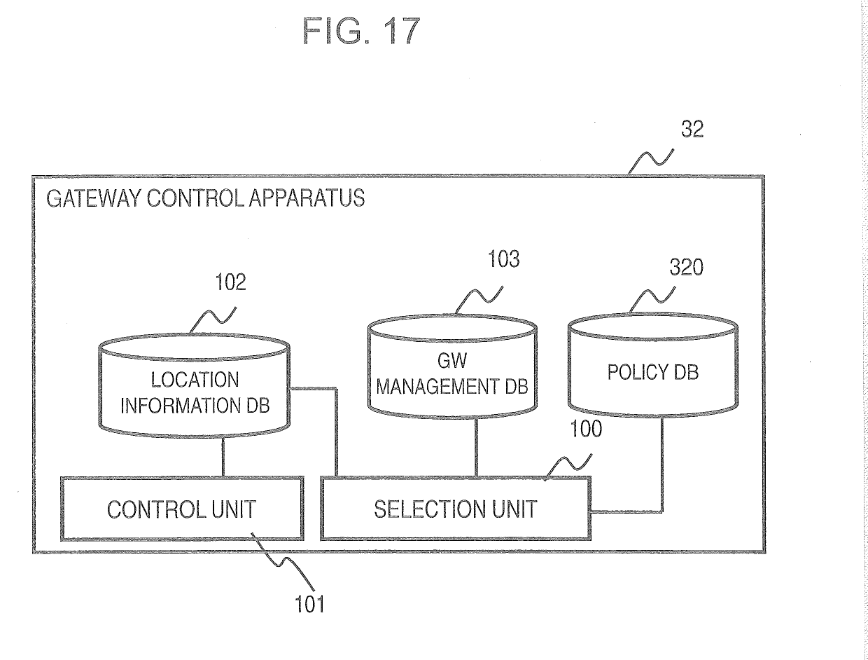

FIG. 17 is a diagram showing a configuration example of a gateway control apparatus 32 of the present exemplary embodiment. Referring to FIG. 17, with regard to the gateway control apparatus 32, a policy database (policy DB) 320 is added to a configuration of a gateway control apparatus 10 of the first exemplary embodiment. Since the configuration otherwise is similar to the configuration described in the first exemplary embodiment and FIG. 3, a detailed description is omitted.

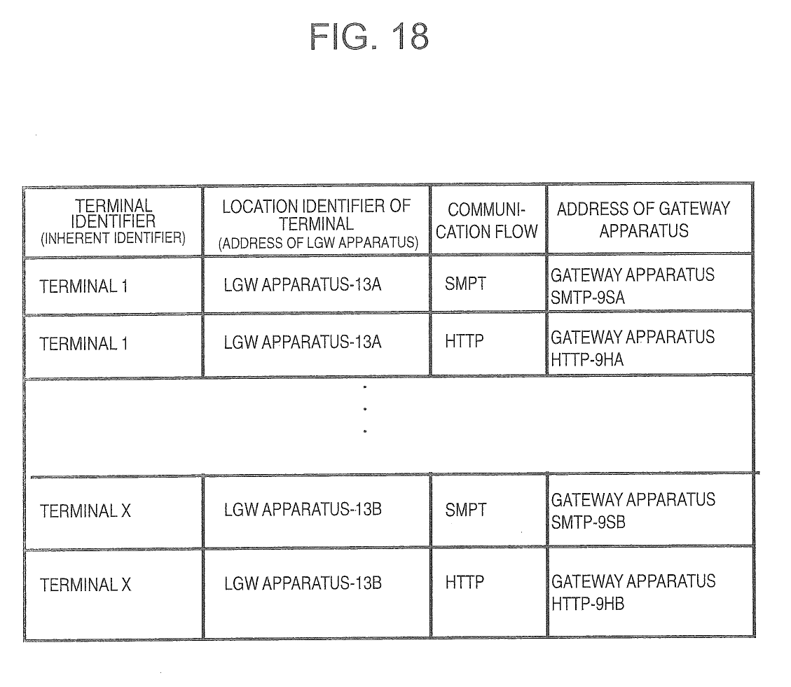

The gateway control apparatus 32 manages a gateway apparatus 9 selected for each communication flow by the policy DB 320. As shown in FIG. 18, the policy DB 320 is a database that associates and manages, for each respective terminal, local gateway apparatuses to which respective terminals are connected, and for each type of communication flow, gateway apparatuses by which each local gateway apparatus is to forward packet(s) corresponding to the respective communication flows.

When a selection unit 100 of the gateway control apparatus 32 selects a gateway apparatus 9 for each communication flow, the selection unit 100 updates the policy DB 320.

The gateway control apparatus 32 notifies the respective local gateway apparatuses 13 of the gateway apparatuses 9 for forwarding traffic of respective terminals connected to the respective local gateway apparatuses 13. That is, the gateway control apparatus 32 refers to the policy DB 320 and specifies the gateway apparatuses 9 for forwarding traffic of the terminals for each communication flow, to the local gateway apparatuses 13.

The gateway control apparatus 32 notifies the control apparatus 16 of the network E 18, of the gateway apparatuses 9 for forwarding packets with destinations of the respective terminals. That is, the gateway control apparatus 32 refers to the policy DB 320, and specifies the gateway apparatuses 9 for forwarding packets with destinations of the respective terminals, for each communication flow, to the control apparatus 16. The gateway control apparatus 32, for example, with regard to a packet having the terminal 1 as a destination, instructs the control apparatus 16 so that a packet belonging to an SMTP communication flow is forwarded to the gateway apparatus-SMTP 9SA, and a packet belonging to an HTTP communication flow is forwarded to the gateway apparatus-HTTP 9HA.

The control apparatus 16 notifies each forwarding apparatus 17 of the network E 18 of a processing rule, based on an instruction from the gateway control apparatus 32.

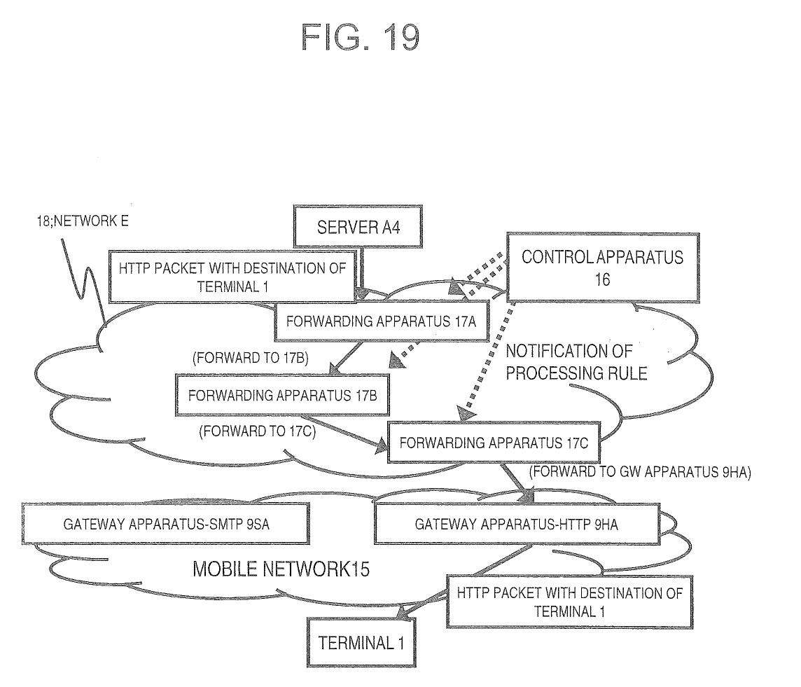

Next, referring to FIG. 19, a description is given of an operational example of the control apparatus 16. The control apparatus 16, for example, notifies each forwarding apparatus 17 of a processing rule specifying a forwarding method of a packet having the terminal 1 as a destination, the packet belonging to an HTTP communication flow.

More specifically, the control apparatus 16, for example, determines a forwarding path of an HTTP packet having the terminal 1 as a destination, being a forwarding path that forwards in a sequence of the forwarding apparatuses 17A, 17B, and 17C. The control apparatus 16 determines a packet processing rule to be notified to each forwarding apparatus in the forwarding path. The control apparatus 16 notifies the forwarding apparatus 17A of a processing rule for forwarding an HTTP packet having the terminal 1 as a destination, to the forwarding apparatus 17B. The control apparatus 16 notifies the forwarding apparatus 17B of a processing rule for forwarding an HTTP packet having the terminal 1 as a destination, to the forwarding apparatus 17C. The calculation unit 16 notifies the forwarding apparatus 17C of a processing rule for forwarding a packet having the terminal 1 as a destination, to the gateway apparatus-HTTP 9HA.

By the abovementioned operations, the forwarding apparatuses of the network E 18 can forward a packet to an appropriate gateway apparatus 9.

In the third exemplary embodiment, the gateway apparatuses 9 used are separated for respective protocols and a plurality thereof are used simultaneously, but there is no limitation thereto. For example, a plurality interfaces may be installed in the terminal 1, a gateway apparatus 9 may be prepared for each interface, and the gateway apparatus 9 may be used in accordance with an IF used in the terminal 1. For example, the terminal 1 may have WiFi and LTE (Long Term Evolution) interfaces installed, the gateway apparatuses 9 may be used according to each IF thereof, and the plurality of gateway apparatuses 9 may be used simultaneously.

Descriptions have been given above of respective exemplary embodiments of the present disclosure, but the present disclosure is not limited to the abovementioned exemplary embodiments, and further modifications, substitutions, and adjustments may be added within a scope that does not depart from fundamental technological concepts of the disclosure. For example, it should be understood that connection relationships of the gateway apparatuses, local gateway apparatuses, gateway control apparatuses, forwarding apparatuses and the like, as shown in the respective exemplary embodiments described above, are shown merely as examples in order to aid understanding of the present disclosure, and there is no particular limitation thereto.

Finally, preferred modes of the present disclosure are summarized.

### First Mode

(See the communication system according to a first aspect described above.)

### Second Mode

The communication system according to the first mode, wherein the gateway control apparatus selects a gateway apparatus in accordance with movement of the terminal, and the path control means (entity) switches a forwarding destination of a packet having the terminal as a destination to the selected gateway apparatus(es).

### Third Mode

The communication system according to the first or second mode, wherein the gateway control apparatus selects a plurality of gateway apparatuses corresponding to the terminal, and uses the selected plurality of gateway apparatuses in respective right places based on a prescribed reference.

### Fourth Mode

The communication system according to any one of the first to third modes, wherein the path control means (entity) controls the first network by notifying the first network of an identifier of the gateway apparatus through which a packet(s), having the terminal as a destination, passes.

### Fifth Mode

The communication system according to any one of the first to third modes, wherein the path control means (entity) controls the first network by instructing a communication apparatus that forwards a packet in the first network, to forward a packet(s) having the terminal as a destination to the selected gateway apparatus.

### Sixth Mode

The communication system according to any one of the first to third modes, wherein the path control means calculates a communication path by which a packet having the terminal as a destination reaches the selected gateway apparatus, and controls the first network by instructing the communication apparatus in the communication path to forward the packet(s) having the terminal as a destination following the communication path.

### Seventh Mode

The communication system according to any one of the first to sixth modes, wherein the gateway control apparatus selects the gateway apparatus based on location information in the second network, of the terminal, notified by the terminal.

### Eighth Mode

The communication system according to any one of the first to sixth modes, wherein a local gateway apparatus is provided to communicate with the gateway apparatus in place of the terminal in the second network, and the gateway control apparatus selects the gateway apparatus based on location information of the terminal notified by the local gateway apparatus.

### Ninth Mode

(See the gateway control apparatus according to a second aspect described above.)

### Tenth Mode

(See the path control apparatus according to a third aspect described above.)

### Eleventh Mode

(See the communication method according to a fourth aspect described above.)

### Twelfth Mode

(See the program according to a fifth aspect described above.)

The respective disclosures of the Patent Literature and Non Patent Literature described above are hereby incorporated by reference into this specification. The exemplary embodiments and examples may be changed and adjusted within the bounds of the entire disclosure (including the scope of the claims) of the present disclosure and based on fundamental technological concepts thereof. Furthermore, a wide variety of combinations and selections of various disclosed elements (including respective elements of the respective claims, respective elements of the respective exemplary embodiments and examples, respective elements of the respective drawings, and the like) is possible within the scope of the claims of the present disclosure. That is, it is to be understood that the present disclosure includes every type of transformation and modification that a person skilled in the art can realize according to the entire disclosure including the scope of the claims and to technological concepts thereof.

### REFERENCE SIGNS LIST

1, X1 terminal
4, X4 server A
9, 9A, 9B, . . . , 9N, 9SA, 9SB, 9HA, 9HB gateway apparatus
10, 22, 32 gateway control apparatus
11 external network
12 mobile communication network
13, 13A, 13B local gateway control apparatus
14 L2 network
15 mobile network
16 control apparatus
17, 17A, 17B, 17C forwarding apparatus
18 network E
19 OpenFlow controller
20 OpenFlow switch
21 path control means (entity)
22, 32 gateway control apparatus
26 mail server
27 HTTP server
90 path control unit
91 control unit
92 location information database (location information DB)
100 selection unit
101 control unit
102 location information database (location information DB)
103 gateway management database (GW management DB)
130 control unit
131 connection management database (connection management DB)
161 node communication unit
162 control message processing unit
163 calculation unit
164 topology management unit
165 location management unit
167 DB management unit
168 processing rule database (processing rule DB)
191 secure channel
201 flow table
320 policy DB
X2 MAG-A, MAG-B
X3 LMA
X5, X6 network

What is claimed is:

1. A communication system, comprising:
a plurality of gateway apparatuses that connect a first network and a second network;
a gateway control apparatus that selects at least one of said plurality of gateway apparatuses based on information related to location in said second network of a terminal that communicates with said first network via at least one of said plurality of gateway apparatuses; and
path control means for controlling said first network so that a packet(s) having said terminal as a destination passes through said selected gateway apparatus(es).

2. The communication system according to claim 1, wherein
said gateway control apparatus selects a gateway apparatus in accordance with movement of said terminal, and
said path control means switches a forwarding destination of a packet having said terminal as a destination, to said selected gateway apparatus(es).

3. The communication system according to claim 1, wherein said gateway control apparatus selects a plurality of gateway apparatuses corresponding to said terminal, and uses said selected plurality of gateway apparatuses in respective right places based on a prescribed reference.

4. The communication system according to claim 1, wherein said path control means controls said first network by notifying said first network of an identifier of said gateway apparatus through which a packet(s), having said terminal as a destination, passes.

5. The communication system according to claim 1, wherein said path control means controls said first network by instructing a communication apparatus that forwards a packet in said first network to forward a packet(s) having said terminal as a destination, to said selected gateway apparatus.

6. The communication system according to claim 1, wherein said path control means
calculates a communication path by which a packet having said terminal as a destination reaches said selected gateway apparatus, and
controls said first network by instructing said communication apparatus in said communication path to forward said packet(s) having said terminal as a destination, following said communication path.

7. The communication system according to claim 1, wherein said gateway control apparatus selects said gateway apparatus based on location information in said second network, of said terminal, notified by said terminal.

8. The communication system according to claim 1, wherein
a local gateway apparatus is provided to communicate with said gateway apparatus in place of said terminal in said second network, and
said gateway control apparatus selects said gateway apparatus based on location information of said terminal notified by said local gateway apparatus.

9. The communication system according to claim 1, wherein said gateway control apparatus additionally refers to distance between said gateway apparatus and a communication partner at said terminal in said first network, and selects said gateway apparatus.

10. A gateway control apparatus, that selects at least one of a plurality of gateway apparatuses, based on information related to location of a terminal that communicates with a first network, in a second network, via at least one of said plurality of gateway apparatuses that connect said first network and said second network.

11. A path control apparatus, that is connected to said gateway control apparatus of claim 10, and that controls said first network so that a packet(s) having said terminal as a destination passes through said selected gateway apparatus(es).

12. A communication method, comprising:
selecting at least one of a plurality of gateway apparatuses, based on information related to location of a terminal that communicates with a first network, in a second network, via at least one of said plurality of gateway apparatuses that connect said first network and said second network; and
controlling said first network so that a packet(s) having said terminal as a destination passes through said selected gateway apparatus.

13. The gateway control apparatus according to claim 10, wherein
said gateway control apparatus selects a gateway apparatus in accordance with movement of said terminal, and
causing a path control means to switch a forwarding destination of a packet having said terminal as a destination, to said selected gateway apparatus(es).

14. The gateway control apparatus according to claim 10, wherein said gateway control apparatus selects a plurality of gateway apparatus corresponding to said terminal, and uses said selected plurality of gateway apparatuses in respective right places based on a prescribed reference.

15. The gateway control apparatus according to claim 10, wherein said gateway control apparatus selects said gateway apparatus based on location information in said second network, of said terminal, notified by said terminal.

16. The gateway control apparatus according to claim 10, wherein said gateway control apparatus additionally refers to distance between said gateway apparatus and a communication partner at said terminal in said first network, and selects said gateway apparatus.

17. The path control apparatus according to claim 11, wherein said path control apparatus controls said first network by notifying said first network of an identifier of said gateway apparatus through which a packet(s), having said terminal as a destination, passes.

18. The path control apparatus according to claim 11, wherein said path control apparatus controls said first network by instructing a communication apparatus that forwards a packet in said first network to forward a packet(s) having said terminal as a destination, to said selected gateway apparatus.

19. The path control apparatus according to claim 11, which said path control apparatus
calculates a communication path by which a packet having said terminal as a destination reaches said selected gateway apparatus, and
controls said first network by instructing said communication apparatus in said communication path to forward said packet(s) having said terminal as a destination, following a communication path.
